(19) United States
(12) Patent Application Publication
(10) Pub. No.: US 2010/0235250 A1
(43) Pub. Date: Sep. 16, 2010

(54) TRACKING ITEMS IN A DISTRIBUTION CHANNEL

(75) Inventor: Kfir Bar-Levav, Elad (IL)

Correspondence Address: MARTIN D. MOYNIHAN d/b/a PRTSI, INC., P.O. BOX 16446, ARLINGTON, VA, 22215, US

(73) Assignee: Planetech Inc., Ramat-Gan (IL)

(21) Appl. No.: 12/303,762

(22) PCT Filed: Jun. 7, 2007
(86) PCT No.: PCT/IL07/00690

§ 371 Date: Jun. 2, 2010

Related U.S. Application Data
(60) Provisional application No. 60/901,314, filed on Feb. 15, 2007.
(60) Provisional application No. 60/822,525, filed on Aug. 16, 2006.
(60) Provisional application No. 60/804,177, filed on Jun. 8, 2006.

(51) Int. Cl. G06Q 10/00; G06Q 30/00; G06K 7/00; G06K 19/06; G06K 19/067; G06F 17/30

(52) U.S. Cl. 705/23; 705/302; 235/375; 235/380; 705/16; 235/493; 235/492; 705/28; 707/802; 707/E17.005

(57) ABSTRACT

A method of providing inventory control service to a point of sale, the method comprising: providing readers adapted to read a unique identifier (UID) of a purchased item and transmit the UID to a database together with a reader identification code (RIC) of a specific reader; implementing reading of UIDs by the readers as items are purchased; and allowing access to data transmitted from a designated set of readers to an authorized party.

This application claims priority from US provisional applications: 60/804,177 filed Jun. 8, 2006; 60/822,525 filed Aug. 16, 2006 and 60/804,177 filed Feb. 15, 2007, the disclosures of which are each fully incorporated herein by reference.

### FIELD OF THE INVENTION

The present invention relates to registration of items and/or people in a database.

### BACKGROUND OF THE INVENTION

In the current global marketplace, the manufacturer of goods is often far removed from the end user of manufactured goods. In many cases, the goods change hands a number of times before they are eventually transferred to the end user.

FIG. 1 is a simplified flow diagram of an exemplary prior art distribution channel 100 for a single manufacturer 110 of goods. Distribution channel 100 is depicted as having two parallel paths 120 and 140.

Each path represents a separate market, for example a market defined by the borders of a country or the borders of a defined marketing territory.

Each path begins with an importer (124 or 144) that receives relatively large quantities of goods directly from the manufacturer 110. The number of single items of a specific model imported by the importer may vary. The variation may be, for example, in inverse proportion to price.

Each importer transfers lots of goods to distributors (e.g. 126 and 146). The lots received by distributors often, but not always, contain smaller quantities of goods of a specific type than the quantity received by the importer.

The distributors, in turn, distribute the goods throughout the market in lots, typically smaller lots, to wholesalers (e.g. 128 and 148).

Wholesalers then distribute small lots of goods to retailers (e.g. 130 and 150) that sell individual units or items to the end users. In the case of expensive luxury items, a wholesaler may provide a retailer with a single item of a certain type (e.g. a wristwatch with a price in excess of $10,000).

For clarity, a single distributor is depicted for each importer; a single wholesaler is depicted for each distributor and a single retailer is depicted for each wholesaler, although, in practice, the numbers of participants in distribution typically increases as the goods move from manufacturer towards retailer.

In some cases, an unauthorized transfer of goods (e.g. 132 or 134) from one path to another may occur. If each path represents a country, this unauthorized transfer may be referred to as parallel importation.

ANSI/ISO 7810; 7811 (1-6) and 7813 specify standards for Magnetic stripe cards. Each of these standards is fully incorporated herein by reference. For purposes of this specification and the accompanying claims, cards employing magnetic stripes as defined by these standards are referred to as “credit card type cards”. Briefly, a standard card may have one or more of three tracks running the length of a 3.357 inch stripe. Track 1 is 210 bpi with room for 79 characters. It includes the primary account number (up to 18 digits) and the name (up to 26 alphanumeric characters). Track 2 is 75 bpi with room for 40 numeric characters. It includes the account number (up to 19 digits). Track 3 is also used for financial transactions and is 210 bpi with room for 107 numeric digits. It includes an enciphered PIN, a country code, currency units, amount authorized, subsidiary account information and other restrictions. According to the standards, each track is 2.794 mm wide. A standard stripe is characterized by a width of 12 mm so that there is more than 1 mm of empty space between each of the three tracks (if all three are present). The contents of these ANSI/ISO standards are incorporated herein by reference.

Magnetic card readers and/or writers are available from, for example, IDTech (Cypress Calif.; USA) and MagTek. Inc (USA). Some readers are adapted to read both magnetic stripes and bar-codes. Other readers are adapted to read both magnetic stripes and smart chips.

U.S. Pat. Nos. 6,965,866 and 2001/0027401 to Klein teach placing an RFID tag containing a unique identifier (UID) on an item to both register the warranty and facilitate return of the item if lost. The disclosures of these documents are fully incorporated herein by reference.

Omnis Group ISIS POS inventory monitoring system (Integrated Strategic Information Systems: Point of Sale [ISIS: POS]; wwwDOTisisDOTroDOTen) uses bar codes acquired at cash registers to keep track of inventory. ISIS teaches defining “partners” that have access to the acquired data. The ISIS system employs standard cash register bar code readers for acquiring data. The disclosure of the OMNI/ISIS product description documents are fully incorporated herein by reference.

Fuji Photo Film USA's “satisfusion” program offers point of sale warranty registration of digital cameras and creates a database of owner details for follow-up.

U.S. Pat. No. 5,521,815 to Rose Jr. discloses a system for tracking titles for articles of value, such as motor vehicles, boats, land, antiques, etc., in a congruent and continual manner. The disclosure of this patent is fully incorporated herein by reference.

U.S. Pat. No. 6,018,719 to Rogers et al. discloses an electronic registration system which facilitates authorized product returns and reduces the incidence of improper returns. The disclosure of this patent is fully incorporated herein by reference.

### SUMMARY OF THE INVENTION

A broad aspect of some embodiments of the invention relates to sharing inventory data pertaining to specific items among different participants in a sales channel. In some embodiments of the invention a supplier (e.g. a manufacturer) is provided with access to inventory data at the level of specific items of one or more consumers (e.g. importers, distributors, wholesalers, and retailers. Optionally, production and/or shipping schedules are adjusted based upon accessed inventory data. In an exemplary embodiment of the invention, end user requests to issue warranties for specific products by entering a UID into a database at point of sale contribute to ensuring entry of inventory data. In an exemplary embodiment of the invention, points of sale which implement point of sale warranty registration benefit from access to their own inventory data in the database. Optionally, warranty registration is conducted using existing credit card sales registration devices or using dedicated warranty registration devices. In an exemplary embodiment of the invention, inventory data resulting from warranty registration is available over the Internet, optionally using a standard WWW browser (e.g. Firefox or Internet explorer). Optionally, inventory data is provided by a distributor which indicates which items were shipped and delivered to a retailer. Optionally, the shared data includes billing data which is used to track income to the retailer and/or distributor and/or other actors according to a tracking of sales, payment plans, delivery and ordering. Optionally, the payments are tracked by using a same system to enter sales information and enter billing information. Optionally, the warranty system is usable both with credit card payments and with other payment means, such as cash, for example, by swiping a warranty card in a credit-card reader even if payment is by cash. Optionally, credit card payment instructions pass through a computer/server associated with one of the actors in the supply line, rather than directly to the credit card company. Alternatively, information provided to the credit card company may be provided to or accessible by one of the actors.

In an exemplary embodiment of the invention, the shared adapt is accesses as an ERP system without requiring significant infrastructure changes at the store. Optionally, a store owner can access such ERP functions from remote locations.

An aspect of some embodiments of the present invention relates to a method of point of purchase warranty registration of individual items which relies upon entry of a unique identifier (UID) into a database. Optionally, the UID is associated with a physical warranty certificate and/or a unique consumer identifier (CID). Optionally point of purchase registration activates the warranty.

According to various exemplary embodiments of the invention, “association” of the UID with a physical warranty certificate may be physical or electronic. Optionally, electronic association includes linking of the UID with a number present on the warranty certificate in a lookup table in the database. Optionally, the warranty certificate is a document originally issued for some purpose not associated with warranty registration. In an exemplary embodiment of the invention, an identification card or a credit card serves as the warranty certificate. For example, a driver's license bearing a magnetic stripe or bar code encoding a driver's license number may be employed as a physical warranty certificate for one or more items purchased by the license holder. Optionally, warranty registration does not result automatically from a credit card sale.

In an exemplary embodiment of the invention, one or more of an importer, a manufacturer, a distributor, a wholesaler and a retailer have access to at least a portion of data stored in the database.

In an exemplary embodiment of the invention, the retailer is a “mercantile agent” employed to sell goods or merchandise on behalf of the importer and/or the manufacturer. Optionally, the importer is a “local agent” appointed to act as the manufacturer's representative to distribute goods for sale and provide warranty registration and/or service within a specified district on behalf of the manufacturer.

For purposes of this specification and the accompanying claims the phrases “mercantile agent” and “local agent” are to be construed as defined in Black's Law Dictionary; 7th edition (ed. B. A. Garner; West Group; St. Paul Mich., 1999).

In an exemplary embodiment of the invention, the UID is applied to individual items in a post manufacturing process, for example by an importer. Optionally, UIDs applied by importers are used to limit registration of unauthorized imports for warranty service and/or permit the importer to ascertain how many units of an imported lot have been sold to end-users. Optionally, the end user of the item will encourage the retailer to enter the UID into the database to activate the warranty at a point of purchase. In an exemplary embodiment of the invention, this insistence on point of purchase warranty registration by the end-user imparts protection against parallel importation to the importer.

In an exemplary embodiment of the invention, the UID is applied by the manufacturer, for example as a serial number. Optionally, UIDs applied by the manufacturer limit registration of specific items for warranty service in a market other than the market to which they were shipped.

In an exemplary embodiment of the invention, the UID is a machine readable UID. Examples of machine readable UIDs include, but are not limited to, barcodes, RFID tags, magnetic stripes (e.g. of the type commonly found on credit cards) and data stored on a smart chip.

In an exemplary embodiment of the invention, “association” of the UID with a physical warranty certificate includes physical transfer of physical media bearing the UID to the warranty certificate and attachment thereto.

In an exemplary embodiment of the invention, “association” of the UID with a physical warranty certificate includes transfer of digital data representing the UID to the warranty certificate. Optionally, the warranty certificate may be provided as a “credit card” sized plastic card. The credit card sized plastic card may optionally include one or more of a smart chip, a programmable RFID or a magnetic stripe adapted to receive additional data.

An aspect of some embodiments of the present invention relates to the use of standard magnetic card readers to acquire UIDs of individual items and register the UIDs into a database. Optionally, the magnetic card readers are part of a “standard credit card sales registration system”. For purposes of this specification and the accompanying claims, the phrase “standard credit card sales registration system” indicates systems established primarily for the recordation of credit sales for billing purposes. In another exemplary embodiment of the invention dedicated magnetic card readers are supplied primarily for transmission of UIDs to a database for purposes of warranty registration. Optionally, some embodiments of the invention provide added utility to standard credit card sales registration systems.

In an exemplary embodiment of the invention, this registration of UIDs via a credit card sales registration system is part of a point of sale warranty activation process. Optionally, the credit card sales registration system is used to register the UID even if the purchase is made without a credit card (e.g. payment by cash, check or vouchers).

An aspect of some embodiments of the present invention relates to a computerized database of records for individual items of merchandise which is at least partially accessible to multiple parties in the distribution chain and/or to the end users. In an exemplary embodiment of the invention, the individual items are provided with unique identifiers by an importer. In an exemplary embodiment of the invention, the database is updated when an individual item of the specific model is purchased by an end user at a point of purchase. Optionally, the database is updated each time an individual item moves to a different position in the distribution chain. In an exemplary embodiment of the invention, the database indicates how many specific items of a particular model have actually been sold to an end user and how many items are still in the distribution channel.

An aspect of some embodiments of the present invention relates to a machine readable warranty card that is configured at point of sale as part of a warranty registration process.

In an exemplary embodiment of the invention, a unique identifier (UID) for an item of merchandise in the form of a portion of a magnetic strip insertable into a partial stripe on a “credit card” type card is employed in point of sale warranty card configuration. Optionally, the UID is supplied as a piece (e.g. trapezoid or irregular oval) of plastic with a portion of a magnetic stripe bearing the UID on at least one side. During the warranty activation process, the piece of plastic is inserted into a matching empty space on a credit card type card. In an exemplary embodiment of the invention, a non regular shape of the piece encourages correct orientation during insertion. Optionally insertion produces an audible click. Optionally, insertion is by means of an adhesive on the piece and/or in the empty space. Once the UID is incorporated into the magnetic stripe, the owner can establish warranty eligibility by having the card read by a standard card reader at an authorized service location.

In an exemplary embodiment of the invention, a unique identifier UID for an item of merchandise is transferred to a smart chip of a credit card type card as part of a point of sale warranty card configuration. Once the UID is on the smart chip of the card, the owner can establish warranty eligibility by having the card read by a smart chip reader at an authorized service location. Optionally, the smart chip resides on an actual credit card already issued to the purchaser.

An aspect of some embodiments of the present invention relates to permitting employees to “clock in” at multiple locations on a service route using a standard credit card sales registration system to acquire employee identifiers (EIDs) using the same card readers typically used to register credit card sales data. In an exemplary embodiment of the invention, the card bearing the EID is used to execute mock purchases using existing credit card sales registration infrastructure. Optionally, employees clock in by making an actual purchase and clock out by canceling the transaction.

In an exemplary embodiment of the invention, EIDs recorded at multiple locations are used to evaluate performance of service technicians and/or sales representatives.

An aspect of some embodiments of the invention relates to a method of allowing one or more members in a distribution channel to track an item, or a lot of an item, as it moves through various re-sellers below them in the distribution channel. In an exemplary embodiment of the invention, a manufacturer tracks their product at one or more stages in the distribution channel. In an exemplary embodiment of the invention, the manufacturer receives sell-out information about sale of their product by a retailer to a consumer. Optionally, the method includes implementation of a computerized inventory system which requires one or more members in a distribution channel to log receipt and disbursement of inventory.

An aspect of some embodiments of the invention relates to point of sale authenticity certification. In an exemplary embodiment of the invention, point of purchase registration is used to verify that the purchased item arrived in an inventory of the seller through legitimate channels. Authenticity certification can be useful, for example, in the pharmaceutical industry, the jewelry industry, the entertainment industry (e.g. DVDs, CDs, computer software, computer games) and the fashion industry.

An aspect of some embodiments of the invention relates to product recall by a party in a distribution chain from a party that is parallel to them or below them in the distribution chain as a means of filling an order. In an exemplary embodiment of the invention, a possibility of product recall serves as a deterrent to unauthorized disbursement from inventory. In an exemplary embodiment of the invention, product recall contributes to a reduction in production over-runs and/or sales of units of product at reduced prices.

An aspect of some embodiments of the present invention relates to methods for providing inventory control services to points of sale. In an exemplary embodiment of the invention, reading devices installed at points of sale transmit a UID (e.g. a barcode) to a remote database which handles inventory control. Optionally, the reader is integrated into an existing credit card sales registration system or is part of a separate system. Optionally, the separate system records warranty registration data.

In an exemplary embodiment of the invention, the UID (e.g. barcode) used for inventory control and/or warranty registration is separate from an additional identifier used for credit card sales registration.

In an exemplary embodiment of the invention, re-supply of inventory is automated. Optionally, inventory information in the database for specific points of sale is available to a supplier of goods to the relevant point of sale.

An aspect of some embodiments of the invention relates to use of a separate data storage module (e.g. smart chip or RFID) to store warranty information on a credit card.

An aspect of some embodiments of the invention relates to a database including both credit card company information, such as consumer details and billing information, such as used for credit card transaction management by credit card companies, and which requires one set of privacy protection, and a second set of information, for example product sales information or warranty information, which is allowed to have other, generally less stringent, privacy protection. For example, credit card information may not allowed to be shown to outside persons. Sales information may be sent (in some embodiments of the invention) to advertisers, promoters, distributors and/or manufacturers. In other embodiments, the other data is accessible, in raw form and/or in processed for, by various actors. In an exemplary embodiment of the invention, both types of information are provided to the credit card company (or another data storage and/or processing means) at a same time via credit-card (or debit card or other electronic payment method) payment stations. For example, at a sale of a watch, the credit card company may be notified both about the name of customer and credit card number and about time of sale and a unique ID of the purchased product. Optionally, the other data is used to provide ERP-like services to supply lines that are not computerized.

In an exemplary embodiment of the invention, there is provided a method of providing inventory control service to a point of sale, the method comprising:

(a) providing readers adapted to read a unique identifier (UID) of a purchased item and transmit the UID to a database together with a reader identification code (RIC) of a specific reader;

(b) implementing reading of UIDs by the readers as items are purchased; and

(c) allowing access to data transmitted from a designated set of readers to an authorized party.

Optionally, the authorized party comprises an operator of a point of sale at which the designated set of readers is installed.

Optionally, the authorized party comprises a supplier of goods to a point of sale at which the designated set of readers is installed.

Optionally, the method comprises replenishing of depleted inventory items by the supplier.

Optionally, the method comprises implementing reading of UIDs by the readers as items introduced into inventory.

Optionally, the method comprises implementing reading of UIDs by the readers as items leave inventory without being purchased.

In an exemplary embodiment of the invention, there is provided method of activating a warranty for a specific item of a product, the method comprising:

(a) applying a unique identifier (UID) to individual items in a post manufacturing process;

(b) entering the UID into a database; and

(c) associating the UID with a physical warranty certificate separate from the individual items;

wherein the entering is performed by a retailer acting as a mercantile agent.

Optionally, the applying is performed by an importer acting as a local agent for a manufacturer.

Optionally, the association includes a physical transfer of a media bearing the UID to the warranty certificate.

Optionally, the association includes storage of data including the UID on a memory attached to the warranty certificate.

Optionally, the UID is provided in a machine readable format.

Optionally, the entering is performed via a credit card reader.

Optionally, the entering is performed via a smart chip reader.

Optionally, the entering is performed via an IVR phone menu.

Optionally, the entering is performed via an RFID reader.

In an exemplary embodiment of the invention, there is provided a method of warranty registration for a specific item of a product, the method comprising:

(a) incorporating a unique identifier (UID) of a specific item into a credit card type card; and

(b) transmitting the UID to a database using a credit card sales registration system.

Optionally, the incorporating occurs at point of sale.

Optionally, the transmitting occurs at point of sale.

Optionally, the method is performed without registration of a credit card sale.

In an exemplary embodiment of the invention, there is provided a computerized system for acquisition of individual sales records for specific items of merchandise, the system comprising:

(a) recordation devices, each device located at a point of sale, each recordation device adapted to receive a unique identifier (UID) indicative of a specific item being sold;

(b) a database adapted to receive from the recordation devices data indicative of at least the UID and a location and time of the sale and store the data; and

(c) an access module adapted for retrieval of the data from the database, the access module operable by at least a manufacturer of the specific item.

Optionally, the recordation devices are standard credit card readers used in recordation of sales.

Optionally, the system comprises additional recordation devices located at additional points in a distribution channel so that the UID of a single specific item is received two or more times by the database as the single specific item moves from an importer to an end user.

Optionally, the access module is independently operable by multiple parties in a distribution channel.

Optionally, the access module is operable by an end user with respect to the single specific item purchased by the end user.

In an exemplary embodiment of the invention, there is provided a two-part warranty certificate; the certificate comprising:

(a) a token bearing a magnetic media encoded with a unique identifier (UID) of a specific item; and

(b) a card with a magnetic stripe interrupted by a receptacle adapted to retain the token;

wherein the magnetic stripe retaining the token is compatible with a standard magnetic stripe card reader for purposes of reading at least the UID.

Optionally, the token is associated with a package containing the specific item and is transferable to the card at a point of purchase.

Optionally, the token is associated with the specific item and is transferable to the card at a point of purchase.

In an exemplary embodiment of the invention, there is provided a method of registering employee presence, the method comprising:

(a) issuing a plurality of employee cards, each card bearing a machine readable employee identification code (EID);

(b) installing an employee registration module on a plurality of credit card sales registration devices, the module adapting the devices to read and record the EIDs in conjunction with a location identifier of the device and a time and date of a reading; and

(c) maintaining a database containing data pertaining to the reading and recording of the EIDs supplied by the registration module.

Optionally, the reading and recording is performed without recordation of a purchase.

In an exemplary embodiment of the invention, there is provided a magnetic stripe card; the card comprising:

a smart chip adapted to:

(i) receive and store a unique identifier (UID) for a purchased item of merchandise from a smart chip writer at a point of purchase; and

(ii) transmit the UID to a smart card reader operated by a warranty service operator.

Optionally, the card is configured to operate as a credit card.

Optionally, the card is configured to operate as a debit card.

In an exemplary embodiment of the invention, there is provided a method of providing retail sales information to a concerned party, the method comprising:

(a) applying a unique identifier (UID) to individual items in a post manufacturing process;

(b) entering the UID into a database at a point of sale; and

(c) providing access to the database to a concerned party.

Optionally, the concerned party includes a manufacturer of the individual items.

Optionally, the concerned party includes an importer of the individual items.

Optionally, the entering is performed by a retailer serving as a mercantile agent.

In an exemplary embodiment of the invention, there is provided a method of activating a warranty for a specific item of a product, the method comprising:

(a) applying a unique identifier (UID) to individual items in a post manufacturing process;

(b) entering the UID into a database; and

(c) associating the UID with a unique consumer identifier (CID);

wherein the entering is performed by a retailer acting as a mercantile agent and serves to activate the warranty.

Optionally, the CID is a credit card number.

Optionally, the CID is a driver's license number.

Optionally, the CID is a social security number.

Optionally, the CID is a phone number.

Optionally, the CID is a frequent flyer number.

In an exemplary embodiment of the invention, there is provided a method of inventory control, the method comprising:

(a) requiring members of a distribution channel to log receipt and disbursement of items in inventory into a database;
(b) permitting any member in the distribution channel to track items previously in their inventory.

Optionally, a manufacturer can monitor retail sales data for their product in the database at a level of individual units of product.

In an exemplary embodiment of the invention, there is provided a method of verifying authenticity of a product, the method comprising:

(a) requiring members of a distribution channel to log receipt and disbursement of items in inventory into a database;
(b) refusing to log receipt of items if a disbursement of corresponding items is not present in the database; and
(c) logging receipt of items if a disbursement of corresponding items is not present in the database.

Optionally, the method comprises using temporal analysis to determine if corresponding items are present in the database.

Optionally, the method comprises using geographic analysis to determine if corresponding items are present in the database.

Optionally, the method is applied to a product selected from the group consisting of a pharmaceutical, an item of jewelry, an item of machine readable media and an item of apparel.

In an exemplary embodiment of the invention, there is provided a method of filling an order for a product, the method comprising:

(a) locating previously distributed units of product in inventory of one or more parties; and
(b) recalling at least some of the previously distributed units to fill the order.

Optionally, the locating employs or relies upon a search of a database.

In an exemplary embodiment of the invention, a warranty certificate is used to provide a future benefit to a consumer.

Optionally, the future benefit is not related to or is only indirectly related to a warranted product.

Optionally, the future benefit is determined after a purchase for which the warranty certificate is issued.

### BRIEF DESCRIPTION OF THE DRAWINGS

In the drawings, identical structures, elements or parts that appear in more than one drawing are generally labeled with the same numeral in all the drawing in which they appear. Dimensions of components and features shown in the drawings are chosen for convenience and clarity of presentation and are not necessarily shown to scale. The drawings are listed below.

FIG. 1 (prior art) is a flow diagram illustrating exemplary distribution parallel distribution chains for manufactured goods and unauthorized transfer of goods between chains;

FIG. 2 is a flow diagram illustrating an exemplary method for point of sale warranty registration according to some embodiments of the invention;

FIG. 3 is a schematic representation of an exemplary system for point of sale warranty registration according to some embodiments of the invention;

FIG. 4 is a schematic representation of an alternative exemplary system for point of sale warranty registration according to some embodiments of the invention;

FIG. 5 is a schematic representation of an exemplary record from a database as employed in some embodiments of the invention;

FIGS. 6A and 6B are schematic representations of the obverse and reverse of a warranty certification card according to exemplary embodiments of the invention; and

FIG. 7 is a simplified flow diagram of a method according to an exemplary embodiment of the invention.

### DESCRIPTION OF EXEMPLARY EMBODIMENTS

### System Overview

Point of Sale Warranty Registration

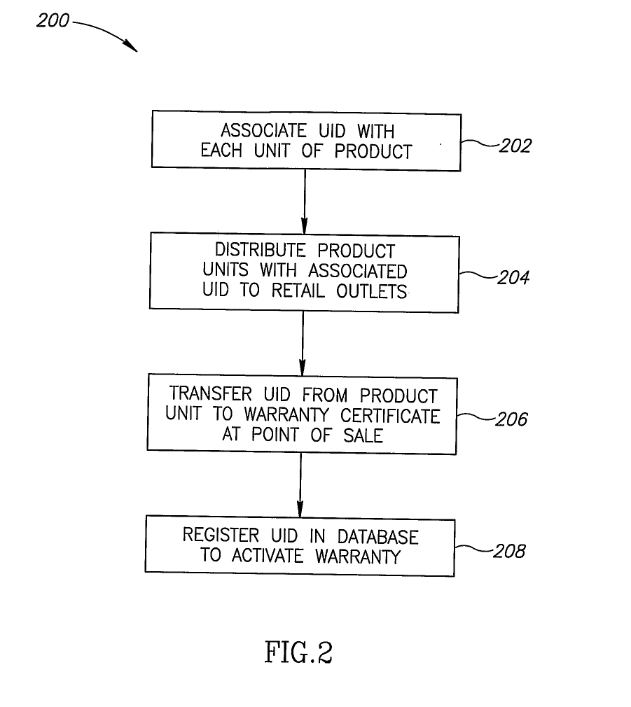

FIG. 2 is a simplified flow diagram illustrating an exemplary sequence of events which occur as part of a warranty registration process 200 according to some embodiments of the invention.

In the diagrammed process 200 a media bearing a unique identifier (UID) is associated 202 with each individual unit of product. Optionally, association of the UID occurs in a post manufacturing process. In an exemplary embodiment an importer provides the UID. The term UID as used in this specification and the accompanying claims can refer to a designation which is “unique” only with respect to a lot of imported goods. For example, if 1000 units of product X are imported on Jan. 1, 2006, the UID might simply indicate “product X; Jan. 1, 2006”. Optionally, the UID may be in the form of “number Y of 1000; product X; Jan. 1, 2006”.

Optionally, the UID is applied by the manufacturer. In an exemplary embodiment of the invention, a product serial number serves as a UID.

Optionally, the UID specifies product details which are more specific than model number. Examples of product details which are more specific than model number include but are not limited to, color, size, installed options, special deals, specific sub-component identification and/properties and style.

In an exemplary embodiment of the invention, an importer applies the UIDs to individual items in an imported lot of goods. Optionally, this allows the importer to limit parallel importation.

Products with associated UIDs are then distributed 204 to retail outlets. Optionally, distribution 204 is a multistage process involving one or more intermediaries between importer and retailer.

At the point of sale, the UID is optionally transferred from the product to a physical warranty certificate. Transfer 206 of the UID may be a physical transfer or a transfer of data.

Registration 208 of the UID in a database activates the warranty. Optionally, warranty activation motivates consumers to register the purchased products. Optionally, consumers are provided with an additional incentive for warranty registration. This additional incentive may take the form of a tangible premium (e.g. a free carrying case for a digital camera), an offer of future discounts on related products and/or at related retailers or a membership in a consumer club. Alternatively or additionally, retailers are provided with an incentive for warranty registration. This retailer's incentive may be, for example, a rebate provided by the manufacturer or importer and/or access to information on customers registering the warranty. Optionally, the information on customers includes contact information (e.g. phone number, mailing address and e-mail address) and/or information on past and/or future buying habits of the customer.

The order of transfer 206 and registration 208 is not fixed in all embodiments of the invention. Optionally, these processes may be performed concurrently or in reverse order according to various embodiments of the invention.

In order to perform process 200, equipment to perform registration 208 is optionally provided at each point of sale. According to various exemplary embodiments of the invention, this equipment may be dedicated primarily to warranty registration or may be used primarily for a purpose not related to warranty registration.

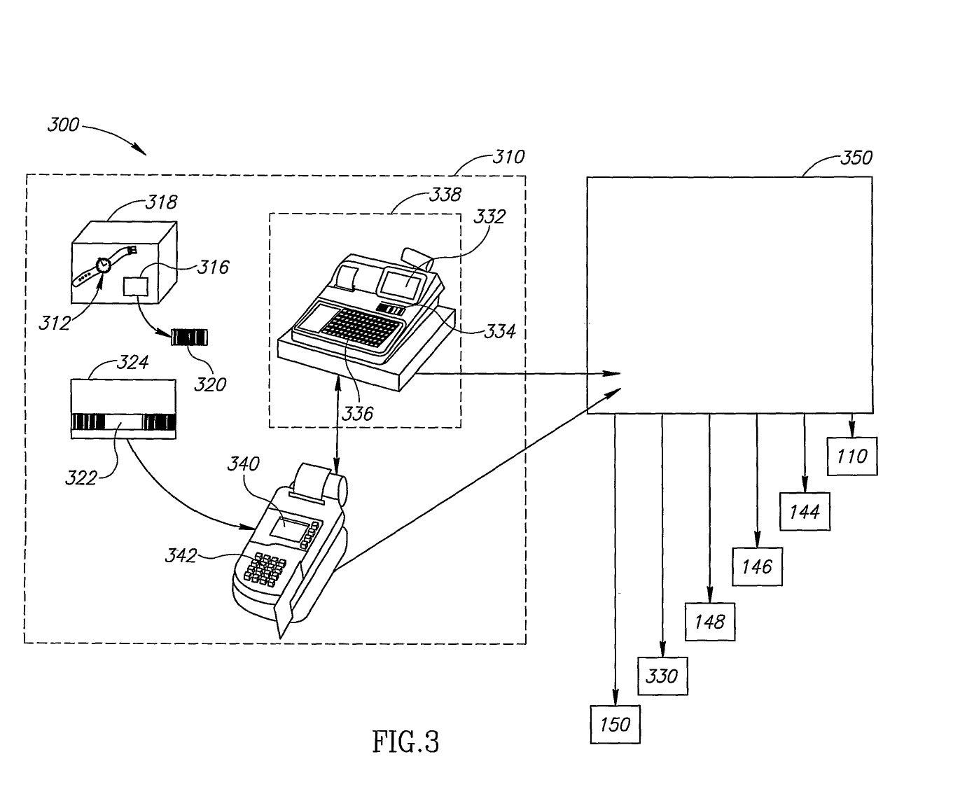

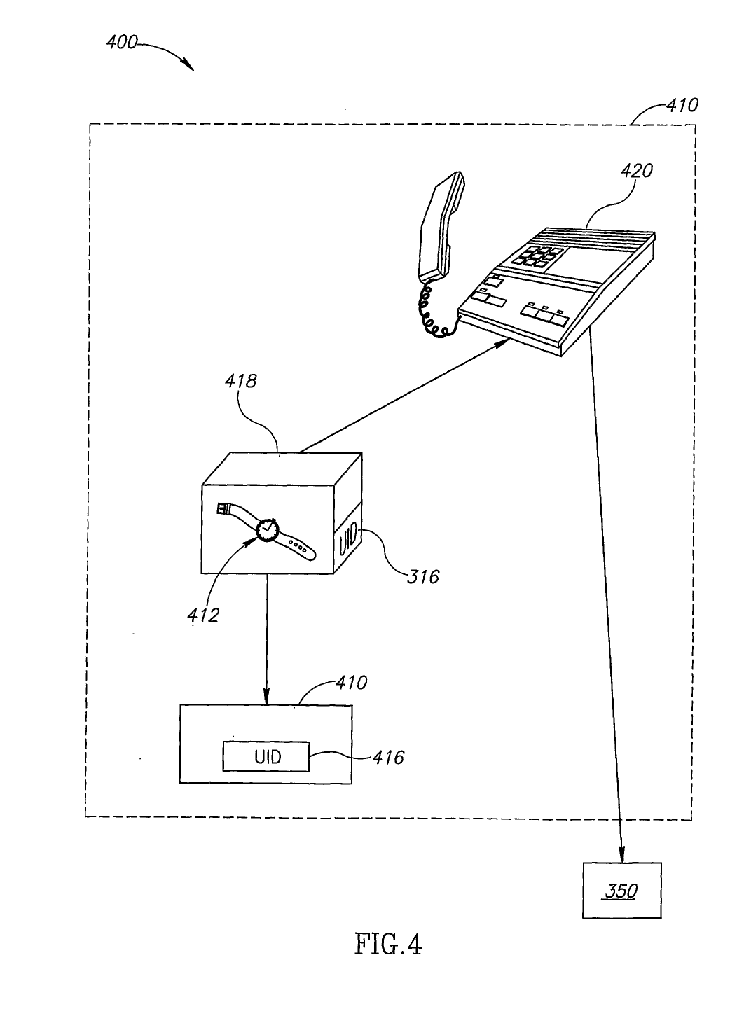

FIGS. 3 and 4 illustrate exemplary systems (300 and 400 respectively) for warranty registration 208. While a single point of sale 310 or 410 is depicted in each figure, an exemplary system according to an embodiment of the invention might include tens, hundreds, thousands, tens of thousands or intermediate or greater numbers of points of sale. FIGS. 3 and 4 illustrate alternate exemplary configurations of equipment for registration 208 suitable for installation at a point of sale. The illustrated systems also include a database 350. In an exemplary embodiment of the invention, a single database 350 residing in a memory of a remote server receives data from multiple points of sale.

In an exemplary embodiment of the invention, the hardware employed at points of sale for warranty registration includes computerized cash registers and/or credit card sales registration equipment. Optionally, additional software is installed on these devices and/or on remote servers with which they communicate to facilitate warranty registration according to various embodiments of the invention.

Use of Machine Readable UID

FIG. 3 illustrates an exemplary system 300 which relies upon a card reader 342 to read a UID borne on magnetic media. Optionally, reader 342 is a bar code reader and the UID is provided as a bar code.

In an exemplary embodiment of the invention, an individual item 312, such as a wristwatch is provided in a package 318 which has a UID token 320 applied to an attachment point 316. Attachment point 316 is optionally on an outer surface of package 318 as pictured or optionally on item 312. Use of an attachment point 316 on the outside of package 318 means that an importer can attach token 320 to package 318 without breaking a manufacturer's seal. For some types of items 312, such as wristwatches, which are often separated from the manufacturer's package to facilitate retail display, an attachment point 316 on the item 312 may be more convenient.

In an alternate exemplary embodiment of the invention, token 320 is supplied by the manufacturer and is contained within package 318.

In an exemplary embodiment of the invention, token 320 includes magnetic media encoded with a UID for item 312.

Optionally, token 320 is removed from package 318 and inserted in receptacle 322 on a card 324. Cards 324 may be supplied to retailers, for example, by importers. According to exemplary embodiments of the invention, cards 324 may be distributed freely because they are of little value without tokens 320.

In an exemplary embodiment of the invention, card 324 is configured as a “credit card” type plastic card so that it is readable by a standard credit card reading device 342. Optionally, token 320 inserted in receptacle 322 completes a magnetic stripe. Optionally, token 320 is a complete magnetic stripe. One of ordinary skill in the art will be capable of preparing tokens using commercially available magnetic card writers. As explained in some detail below, alignment of ±1 mm between the token and the remainder of the stripe should be sufficient to allow reading of the completed stripe.

In an exemplary embodiment of the invention, cards 324 with receptacles 322 are distributed separately from tokens 320. Optionally, a retail outlet receives a large number of cards 324 in advance and receives tokens 320 only with delivery of actual merchandise. In an exemplary embodiment of the invention, separate provision of cards 324 and tokens 320 reduces the likelihood of unauthorized distribution of individual units by non-retail merchants by making warranty registration difficult.

In an exemplary embodiment of the invention, cards 324 with receptacles 322 are distributed together with tokens 320. Optionally, a retail outlet receives a number of cards 324 corresponding to a number of tokens 320 with each delivery of merchandise. In an exemplary embodiment of the invention, provision of cards 324 and tokens 320 together with a consignment of merchandise reduces the non-legitimate use of cards 324.

In an exemplary embodiment of the invention, the portion of the stripe on card 324 contains data such as, for example, importer identification and/or distributor identification and/or wholesaler identification and/or retailer identification. Optionally, some of this non-UID data is provided on token 320. Optionally, the additional data is also read and transmitted by card reader 342 when card 324 is passed through the reader for warranty registration.

A standard magnetic stripe of the type employed on credit cards can hold a total of 37 characters. In an exemplary embodiment of the invention, 10 characters are used to define a UID. Additional characters may be used to define members of the distribution chain such as, for example, importer, distributor, wholesaler or retailer. Optionally, the importer is defined by 2 digits, the distributor is defined by 3 digits, the wholesaler is defined by 5 digits and the retailer is defined by 10 digits.

When card 324 including token 320 is read by card reader 342 during warranty registration, the UID stored on token 320 is transmitted to database (DB) 350. Optionally, the additional data on the stripe of card 324 is also transmitted to DB 350. This transmission registers the UID and activates the warranty of item 312. In an exemplary embodiment of the invention, UIDs transmitted from tokens 320 are verified against a list of permitted UIDs for point of sale 310. The reading of card 324 by reader 342 is similar to the reading of a consumer club card.

In an exemplary embodiment of the invention, a UID from an item 312 shipped to Toronto, Canada, might be refused if it is being registered from a point of sale 310 in Chicago, Ill. Alternatively, registration of a UID from an item 312 shipped to Toronto, Canada, from a point of sale 310 in Chicago, Ill., might cause the system to issue a warning message to the importer and/or the manufacturer. Optionally, the retailer performing the point of sale registration, or other parties in the distribution chain, might be subject to an economic penalty for participating in parallel importation.

Optionally, data transmission is directly from card reader 342 to DB 350, and/or through an intermediate device (e.g. computerized cash register 338). In an exemplary embodiment of the invention, warranty registration includes registration of data pertaining to the person purchasing item 312. The data pertaining to the person purchasing item 312 might include, for example, name and/or address and/or telephone number and/or e-mail address. Optionally, entry of this additional data is via a keypad on card-reader 342 or a keypad 336 on register 338. Optionally, confirmation of a successful UID registration/warranty activation is provided on a display (e.g. 340 or 332). Optionally, a device with a full keyboard, such as a computer, is incorporated into the system to make entry of alphanumeric characters easier.

In an exemplary embodiment of the invention, the function of card reader 342 may be performed by a credit card sales registration device 334 built into cash register 338. Optionally, sales registration device 334 transmits the UID to DB 350 even if item 312 is not being purchased with a credit card. In an exemplary embodiment of the invention, device 334 is programmed with software for warranty registration. In an exemplary embodiment of the invention, the warranty registration is formatted as a “dummy” credit card purchase so that a need for warranty registration software is reduced.

According to various exemplary embodiments of the invention, database 350 may reside on a server operated by a credit card company or a clearinghouse for multiple credit card companies or may be maintained on a server dedicated for warranty registration. In an exemplary embodiment of the invention, a database 350 residing on a server operated by a credit card company provides warranty registration even for items purchased with cash, checks, vouchers or other non-credit card payment means.

In alternate exemplary embodiments of the invention, card reader 342 is replaced by a smart chip reader or an RFID reader or a bar code reader. According to the exemplary embodiments of the invention, token 320 (e.g., including a smart chip or an RFID tag or bar code) may be transferred physically to card 324 or data representing the UID may be transferred from token 320 to a data storage device (smart chip or an RFID tag) already present on card 324.

Once warranty registration is complete, a card 324 bearing token 320 may be presented at any warranty service location. Warranty service locations are provided with card readers 342 adapted to communicate with database 350 for purposes of warranty verification. Optionally, these card readers are standard credit card sales registration devices. Optionally, these card readers are dedicated devices supplied specifically for warranty registration.

In an exemplary embodiment of the invention, communication of warranty service locations with DB 350 permits the manufacturer to determine if product malfunctions are associated with specific geographic areas and/or production lots of merchandise. Optionally, communication of warranty service locations with DB 350 permits the manufacturer to identify “lemons”. In an exemplary embodiment of the invention, the manufacturer initiates product recalls for specific items and/or specific production lots of merchandise if serious performance problems are detected.

Software Considerations

In an exemplary embodiment of the invention, card reader 342 accomplishes warranty registration in DB 350 using standard software provided by a credit card sales registration clearinghouse.

In other exemplary embodiments of the invention, the credit card sales registration clearinghouse installs additional software on readers 342 and/or in database 350 to facilitate warranty registration. In an exemplary embodiment of the invention, database 350 includes a look-up table which translates product ID codes to warranty term (e.g. in number of days).

In other exemplary embodiments of the invention, card reader 342 is a dedicated device equipped with warranty registration software. Optionally, database 350 is not maintained by a credit card clearinghouse.

Exemplary Multi-Level Registration System

In an exemplary embodiment of the invention, one or more members in a distribution channel (e.g. manufacturer 110 and/or importer 124) can track an item, or a lot of an item, as it moves through distribution channel 120 and/or 140. Optionally, manufacturer 110 tracks their product at one or more stages in distribution channel 120 and/or 140 by monitoring database 350. For example, manufacturer 110 may monitor sell-out information about sales of their product by retailer 130 and/or 150 to consumers 330. Optionally, manufacturer 110 makes supply of merchandise to one or more of importers (e.g. 124 or 144), distributors (e.g. 126 or 146), wholesalers (e.g. 128 or 148) and retailers (e.g. 130 or 150) condition upon logging receipts and disbursements of merchandise to database 350.

In an exemplary embodiment of the invention, each party in the distribution channel is assigned a unique business identifier (UBD). Optionally, the UBD is associated with a reader (e.g. a cash register 338 or card reader 332) configured to read UIDs and transmit them to database 350. One exemplary way of associating a UBD with a reader is to use an IP address assigned to the reader. Another exemplary way of implementing a UBD is to assign a smart card with the UBD to each business. Optionally, a single business might have a different UBD for each importer 124 and/or manufacturer 110. Another exemplary way of implementing a UBD is to transmit data via a telephone line and use the phone number to identify a sender of the data. Optionally, an existing caller ID system is employed for this purpose. In an exemplary embodiment of the invention, the reader has an acquisition mode and a disbursement mode. Optionally, a user of the reader selects an appropriate mode before reading UIDs of merchandise entering or leaving inventory respectively. Optionally, the reader is equipped with an auxiliary device, such as a barcode reader, to expedite logging of multiple items without unpacking shipping cartons. In an exemplary embodiment of the invention, master UIDs (described below) contribute to expediting logging of merchandise transfers.

In an exemplary embodiment of the invention, a transmitting party and a receiving party each log transfer of product. For example distributor 126 may log disbursement of cartons of product as they are loaded on a truck and wholesaler 128 may log receipt of the same product as it is received at a loading dock.

Alignment of Token with Magnetic Stripe

According to the ANSI/ISO standards, a standard magnetic stripe is characterized by a width of 12 mm and each track on the magnetic stripe is 2.794 mm wide. As a result, there is more than 1 mm of empty space between each of the three tracks (if all three are present). Therefore, a token aligned with a stripe by “snapping” into place which aligns with a tolerance of ±0.1 mm across the width of the stripe should allow any or all of the three standard tracks to be aligned accurately for reading.

With respect to correct decoding of bits along the length of the stripe, each track has different constraints. Presuming a standard magnetic stripe of 3.357 inches length:
Track 1 is encoded at 210 bpi for a total of 704 bits which encode up to 79 characters. This means that on track 1, each character can be encoded by 8 bits or more. In practice, only 7 bits are actually used for each character. Each bit will occupy 0.00476 inches (0.121 mm) of stripe length.
Track 2 is encoded at 75 bpi for a total of 251 bits which encode up to 40 numeric characters. This means that on track 2, each character can be encoded by 6 bits or more. In practice 5 bits per character are employed. Each bit will occupy 0.01346 inches (0.34 mm) of stripe length.
Track 3 is encoded at 210 bpi for a total of 704 bits which encode up to 107 numeric digits. This means that on track 3, each digit can be encoded by 6 bits or more. In practice 5 bits per character are employed. Each bit will occupy 0.01346 inches (0.34 mm) of stripe length.

In an exemplary embodiment of the invention, only numeric digits are encoded on the magnetic stripe of the warranty card and track 2 and/or track 3 is employed. In an exemplary embodiment of the invention, token 320 contains a portion of a magnetic stripe of the standard 12 mm width to facilitate easy handling. Optionally, some characters are used to define a warranty length (e.g. in number of days).

In an exemplary embodiment of the invention, alphanumeric characters are encoded on the magnetic stripe of the warranty card and track 1 is employed.

In an exemplary embodiment of the invention, a start sentinel (tracks 2 and/or 3) or field separator and/or special character (track 1) are employed to indicate a border between token 320 and the remainder of the stripe. Optionally, this reduces the stringency for linear tolerance of the card reader. In an exemplary embodiment of the invention, a first start sentinel appears at the leading edge of the stripe, a second start sentinel appears at the leading edge of token 320 and a third start sentinel appears at the leading edge of the stripe after receptacle 322.

Optionally, serrated or otherwise non-straight edges on token 320 are employed to increase accuracy of alignment with the remainder of the stripe.

UID Entered Manually

FIG. 4 illustrates an exemplary system 400 which relies upon manual entry of a UID 316, for example, via a telephone 420 at point of sale 410.

In an exemplary embodiment of the invention, UID 316 is affixed to package 418 of item 412. Affixation may be, for example by means of an adhesive crack and peel sticker applied to a backing which is permanently attached to package 418. In order to register UID 316 in DB 350 and activate warranty card 410, UID 316 is transferred to warranty card 410 and the UID is entered into DB 350 manually, for example, using an IVR menu accessed by telephone 420 at point of sale 410. At this point, validated UID 416 is on warrant certificate 410.

In an alternate exemplary embodiment of the invention, telephone 420 is replaced by a computerized cash register or a computer adapted to permit manual entry of data into DB 350.

Use of a Machine Readable Document as a Warranty Certificate

In another exemplary embodiment of the invention, a document with a machine readable portion functions as a warranty certificate. The document can be, for example, a credit card, an identification document (e.g. driver's license or passport) or a membership card (e.g. a consumer club card or frequent flyer card). In an exemplary embodiment of the invention, the document was originally issued for a purpose not related to warranty registration and continues to serve that purpose after it is used for warranty registration.

Optionally, the document is a warranty service card, optionally a warranty service card issued by importer 144. In an exemplary embodiment of the invention, the warranty service card is a plastic card bearing a unique numeric or alphanumeric sequence which can serve as a CID. In an exemplary embodiment of the invention, warranty service cards of this type are issued to consumers (e.g. children) that do not have any suitable document to use as a warranty certificate.

In an exemplary embodiment of the invention, a single document (e.g. driver's license, credit card or warranty service card)) can be used to register multiple purchases. Optionally, the purchases are for items produced by different manufacturers and/or distributed through different distribution channels (e.g. 120 and 140).

Referring again to FIG. 3, card reader 342 can be used to read the machine readable portion of the document and communicate the machine readable data, or a portion thereof, as a Customer Identifier (CID) to database 350. Optionally, customer data 330 (e.g. name, address, telephone and/or demographic data) is already available to database 350, for example via an additional database maintained by a credit card company or a governmental authority. Optionally, customer data 330 is entered via a keypad on card reader 342 or cash register 338.

UID 320 may be communicated to database 350, for example, via card reader 342. In an exemplary embodiment of the invention, UID 320 and the CID are each machine readable, but are in different formats. For example, UID 320 can be a bar code read by a bar code reader attached to register 338 and the CID can be encoded on a magnetic stripe on a credit card readable by card reader 342.

In general, warranty service relies upon warranty service locations to which a consumer may turn for warranty service. According to this exemplary embodiment of the invention, the document with a machine readable portion can be presented by a consumer when warranty service is requested.

Warranty Registration without a Warranty Certificate

In another exemplary embodiment of the invention, a unique personal identifier is employed as a CID. Optionally, the unique personal identifier is an identification number (e.g. social security number) or a telephone number (e.g. cellular telephone number). According to this exemplary embodiment, the CID can be relayed to database 350 and no physical warranty certificate is employed.

Optionally, the CID may be an existing unique personal identifier such as, for example, a social security number or frequent flyer number. While these numbers are often issued on cards, the card itself is not employed in this exemplary embodiment of the invention.

Referring again to FIG. 4, the CID and/or UID can be relayed to database 350 via telephone 410.

Referring again to FIG. 3, the CID and/or UID can be relayed to database 350 via a keypad of card reader 342.

According to this exemplary embodiment of the invention, the CID can be presented (e.g. verbally) by a consumer when warranty service is requested.

Exemplary DB Construction

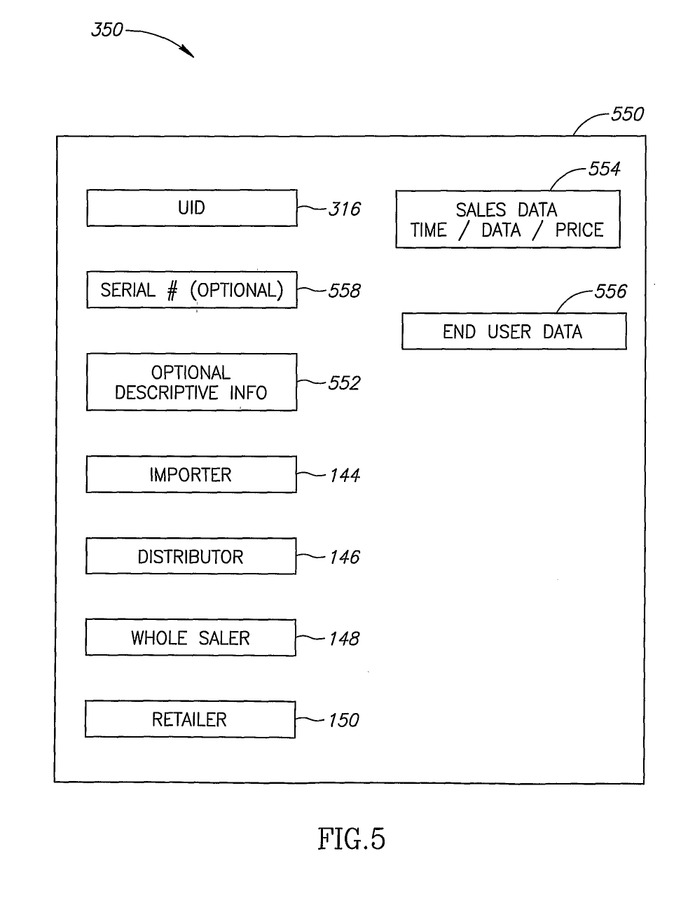

FIG. 5 illustrates an exemplary sales record 550 residing in DB 350. Record 550 includes UID 316 and may optionally include a manufacturer's serial number 558 and/or descriptive information 552 about item 312.

In an exemplary embodiment of the invention, record 550 includes sales data 554 including point of purchase 310 and optionally including time and/or date and/or price and/or purchase price and/or purchase method.

Optionally, record 550 includes end user data 556 (e.g. one or more of name, address, phone number (e.g. mobile phone number), fax number and e-mail address). Alternatively, end user data may be stored in a separate table or record in database 350 and linked to individual item records 550. In an exemplary embodiment of the invention, a single user registers multiple item warranties and provides user data 556 only during a first registration process. Optionally, a single warranty certificate 324 is used to register warranties for multiple purchases. Optionally, the multiple purchases are items produced by different manufacturers and/or purchased at different times.

Optionally, database 350 uses a CID to correlate multiple items owned by a single user. The CID may be, for example, a credit card number used in making purchases or a CID assigned by the DB and stored on a smart chip residing in a credit card. While credit card numbers are not permanent, they are often valid for several years. Therefore, they can be useful in registering warranties with a period of several months to a year. Optionally, a credit card could continue to serve as a CID even after it is no longer valid as a credit card, provided that the magnetic stripe remains intact. In some cases, a single consumer carries several credit cards. Optionally, once they registered a warranty on a specific card, they would prefer to use the same card as a CID for subsequent warranty registrations. As described above, in some exemplary embodiments of the invention a permanent CID (e.g. social security number) is employed.

In an exemplary embodiment of the invention, record 550 includes the importer 144 and/or distributor 146 and/or wholesaler 148 and/or retailer 150 for the item identified by UID 316.

Referring again to FIG. 3, in an exemplary embodiment of the invention database 350 is accessible via an access module (e.g. a WWW server or via telephone using an interactive voice response system) which provides different levels of access to records 550 in DB 350. Optionally, a single database 350 includes data pertaining to items manufactured by multiple manufacturers.

In an exemplary embodiment of the invention, manufacturer 110 has access to all records pertaining to items they manufactured. This access permits a manufacturer to follow previously produced merchandise through the distribution channel and/or to tailor future production to anticipated demand in different markets.

In an exemplary embodiment of the invention, importer 144 has access to all records pertaining to items they imported. This access permits an importer to follow previously imported merchandise through the distribution channel and/or to tailor a future importation schedule to anticipated demand in the local market. In an exemplary embodiment of the invention, the importer does not re-order merchandise if a significant amount of a previously imported item is still held by distributors or wholesalers. Optionally, this prevents the importer from holding a large inventory while permitting the importer to meet local demand in a timely fashion. Optionally, importer 144 tracks goods produced by several manufacturers 110.

In an exemplary embodiment of the invention, distributor 146 has access to all records pertaining to items they distributed. This access permits the distributor to ascertain how much of the merchandise they distributed is still in inventory at the wholesale and/or retail level and how much has been sold to end users. Optionally, the distributor does not re-order merchandise if a significant amount of a previously distributed item is still held by wholesalers or retailers. Optionally, distributor 146 tracks goods produced by several manufacturers 110.

In an exemplary embodiment of the invention, wholesaler 148 has access to all records pertaining to items they sold to retailers. This access permits the wholesaler to ascertain how much of the merchandise they distributed is still in inventory at the retail level and how much has been sold to end users. Optionally, wholesaler 148 tracks goods produced by several manufacturers 110.

In an exemplary embodiment of the invention, retailer 150 uses DB 350 for inventory control and planning of future orders from wholesalers, optionally for products manufactured by different manufacturers 110

A DB 350 according to exemplary embodiments of the invention gives each member of the distribution chain access to information which was previously unavailable to them. Optionally, different users of DB 350 are able to generate reports with statistical data on items stored in DB 350. Statistics may include, for example, average residence time at different stages of the distribution time and total time for an imported lot to reach a specified level of retail sales (e.g. 75%)

In an exemplary embodiment of the invention, end user 330 has access to records pertaining to all items they have purchased. In an exemplary embodiment of the invention, end user 330 may access DB 350 via a WWW site by using a user name and/or password and/or CID and/or a number provided on their warranty certificate. Optionally, end user 330 has access via the WWW site to warranty information for all items purchased. In an exemplary embodiment of the invention, end user 330 may purchase extended warranty coverage through the WWW site.

In an exemplary embodiment of the invention, registration 208 of an item by end user 330 activates a membership in a consumer club.

### Warranty Certificate

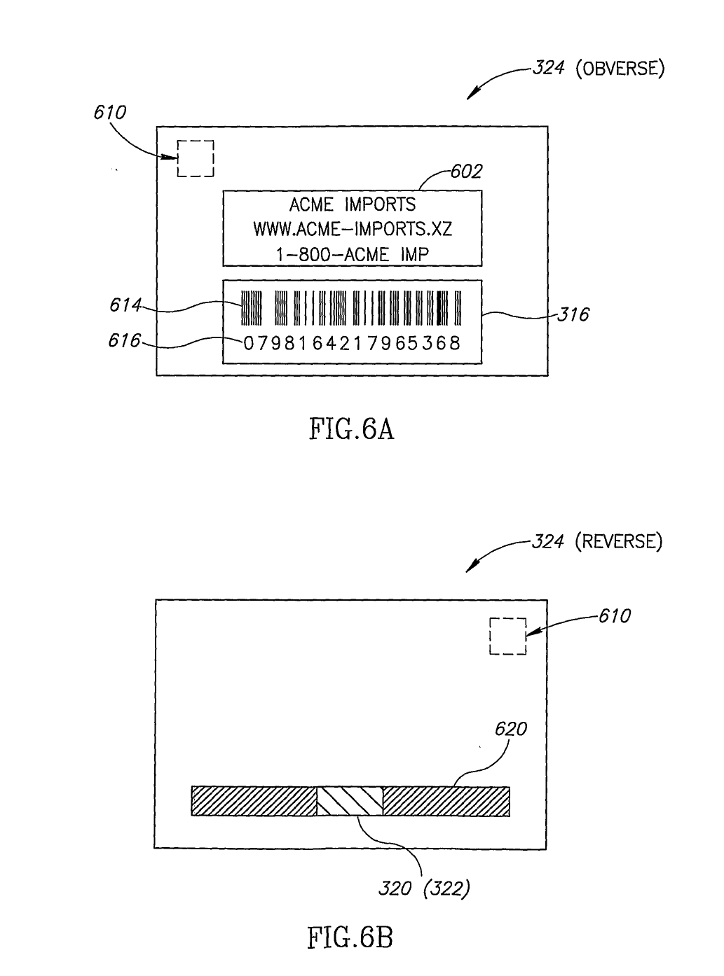

FIGS. 6A and 6B depict schematically the obverse and reverse of a warranty card 324 according to exemplary embodiments of the invention.

FIG. 6A illustrates an exemplary embodiment of warranty card 324 bearing warranty service provider information 602. The warranty service provider information may include, for example a corporate name and/or Internet address and/or telephone number. Optionally, the telephone number is a toll free number. Optionally, a media bearing UID 316 as a machine readable bar code 614 and/or alphanumeric string 616 is affixed to the front of card 324. Optionally, the alphanumeric string is machine readable, for example using optical character recognition (OCR). Alternatively, UID 316 is stored as data on a smart chip 610 or RFID incorporated into card 324.

In an exemplary embodiment of the invention, a smart chip 610 or RFID incorporated into card 324 stores warranty information. Optionally, the warranty information includes one or more of product description, warranty expiration date, warranty terms (e.g. parts are covered but labor is not covered) and the UID of the covered item. In an exemplary embodiment of the invention, warranties for several items are stored on a single smart chip 610 or RFID. Optionally, each of the items is purchased at a different time and/or point of purchase and/or is manufactured by a different manufacturer. Optionally, the same memory unit is used for card related information and for warranty related information. Alternatively a separate memory unit and/or set of contacts and/or wireless readout circuit is provided for card-related information and for warranty information.

FIG. 6B illustrates a token 320 as described hereinabove in a receptacle 322. In an exemplary embodiment of the invention, insertion of token 320 in receptacle 322 completes a magnetic stripe 620. Optionally, insertion of token 320 in receptacle 322 produces an audible click. The click may be produced, for example by friction between edges of token 320 and receptacle 322 and/or bumps and/or interference and/or a snap connection.

### Authenticity Certification

In an exemplary embodiment of the invention, an authenticity certificate is issued at point of purchase after verifying with database 350 that the purchased item arrived in an inventory of the seller through legitimate channels. Optionally, verification relies upon matching of the purchased item with one or more parties above retailer (e.g. 130 or 150) using a multi-level registration system as described above.

Optionally, a physical authenticity certificate is issued and/or an electronic authenticity certificate is available to consumer 330 from database 350. In some exemplary embodiments of the invention, authorization of the sale by the system serves to certify authenticity.

In an exemplary embodiment of the invention, point of sale authenticity certification of this type reduces parallel importation and/or unauthorized production of pharmaceuticals.

In an exemplary embodiment of the invention, point of sale authenticity certification of this type insures that jewelry marketed under a famous name is actually produced by the jeweler on the label. Optionally, a physical certificate of authenticity provided with a jewelry item attests to gemological specifications (e.g. carat weight, clarity, brilliance) and/or origin.

In an exemplary embodiment of the invention, point of sale authenticity certification of this type in the entertainment industry contributes to a reduction in unauthorized re-production and/or distribution of digital media such as, for example DVDs, CDs, computer software and computer games.

In an exemplary embodiment of the invention, point of sale authenticity certification of this type in the fashion industry contributes to a reduction in unauthorized production and/or distribution of “knock-offs” with famous labels.

### Employee Registration System

In an exemplary embodiment of the invention, card readers 334 at points of sale are used to register visits of sales and/or service personnel. Optionally, card readers 334 are normally used to register credit card sales and/or warranties.

Referring again to FIG. 3, in an exemplary embodiment of the invention, cards 324 bearing employee identifiers (EIDs) can be read at retail outlets via card readers 334 on cash registers 338. In an exemplary embodiment of the invention, the same card readers 334 are used to register employee presence at multiple locations, e.g. along a sales route or service route. Optionally, employees pass their cards through reader 334 upon arrival and/or prior to departure from a specific location. Optionally, employees may clock out by having their cards read at restaurants and/or hotels. In an exemplary embodiment of the invention, employee presence is recorded without registration of a credit card sale. In an exemplary embodiment of the invention, each registration of employee presence is registered as a credit card sale. Optionally, the credit card sale has a small value (e.g. 0.05 cents) or a zero value. In an exemplary embodiment of the invention, employee activity is logged in a database 350. Optionally, the database 350 has an access module with different levels of access.

The term EID as used in this specification and the accompanying claims refers to any code which may be used to identify an employee. Optionally, the EID is a number that corresponds to a specific card and is matched to an employee in a separate process. Optionally, the separate process employs a look-up table.

In an exemplary embodiment of the invention, employers 110, 144, 146 and 148 each have access only to data in DB 350 pertaining to their own employees. Optionally, access is via a WWW site or through a software package which provides a graphical user interface tailored to display employee data for management and/or accounting and/or payroll purposes. A software package, if employed, may be provided, for example by the company that issues cards 324 and/or maintains database 350.

In an exemplary embodiment of the invention, a single employee 330 may review their own work record. In an exemplary embodiment of the invention, employees 330 review their work records via a WWW site. Optionally, employees may log in using a user name and/or password and/or the EID.

Potential Advantages to the Manufacturer and/or Importer:

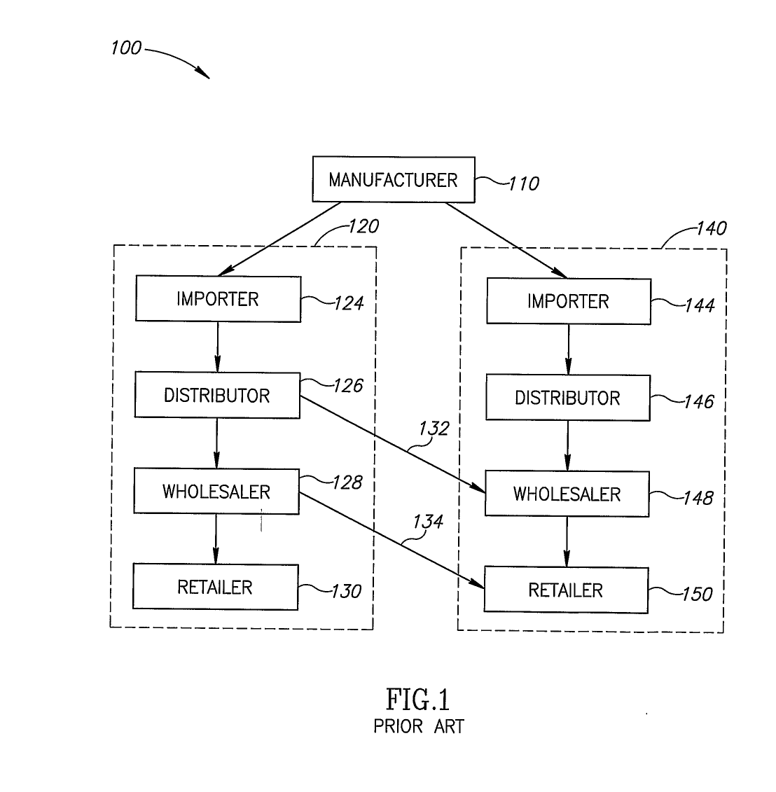

As explained in the background with reference to FIG. 1, a typical marketing channel includes several intermediaries between manufacturer 110 and retailers 130; 150. As a result of these intermediaries, manufacturer 110 is typically able to gauge sales of a specific product only by orders received from importers 124; 144. Orders from importers 124; 144 do not necessarily reflect actual sales by retailers 130; 150.

Similarly, importers 124 and 144 rely upon orders from distributors 126 and 146 to gauge retail sales of a specific product and distributors 126 and 146 rely upon orders from wholesalers 128 and 148 to gauge retail sales of a specific product. Again, orders from distributors and/or wholesalers are not necessarily indicative of actual retail sales.

As an illustrative example, a case of a wristwatch manufacturer 110 is presented. Manufacturer 110 is anxious to tailor production to actual demand. Manufacturer 110 produces a high priced luxury wristwatch and is concerned primarily about overproduction and tying up available funds in inventory (e.g., each unit contains 1200$ worth of gold and diamonds).

Manufacturer 110 meets with representatives of importers 124 and 144 and each importer orders 100 units on January first.

On February first, importer 124 places an additional order for 100 units. On February first importer 144 places no order. Manufacturer 110 infers that the market which importer 124 serves is “hungry” for product while the market served by importer 144 is not interested in the product. This inference is not correct (in this example). In each market 10 units have been sold at retail. The remaining items of each model are in inventory at various levels of each of the two the marketing channels.

Manufacturer 110 and importers 124 and 144 would all benefit greatly if they had access to actual retail sales figures for product. In an exemplary embodiment of the invention, manufacturers and/or importers access actual retail sales data via warranty registration database 350.

In an exemplary embodiment of the invention, a single database 350 contains information on products from multiple manufacturers and multiple distribution channels. Optionally, a single manufacturer 110 has access to distribution information on all products distributed in a plurality of distribution channels. Optionally, single importer 124 has access to distribution information on products from a plurality of manufacturers distributed in the distribution channel in which they operate.

In addition, exemplary embodiments of the invention permit manufacturers and/or importers to detect and/or control parallel importation to a degree not feasible with previously available alternatives. Optionally, control comes from excluding parallel imported goods from warranty registration and/or imposing economic penalties on those members of the distribution chain that participate in distribution/sale of goods imported via an unauthorized channel.

### Product Recall as a Method of Filling Orders

In an exemplary embodiment of the invention, a first part (e.g. manufacturer 110 or importer 124) can recall some or all of a from a second party in a distribution chain that is parallel to them or below them. Optionally, a product recall of this type is used to fill an order from a third party. Optionally, conditions for product recall are part of a contractual agreement between parties in the distribution channel. In an exemplary embodiment of the invention, a possibility of product recall serves as a deterrent to unauthorized disbursement from inventory. For example if distributor 126 has received 100 units of a product from importer 124, the knowledge that importer 126 and/or manufacturer could ask for the return of unsold units which appear in database 350 as part of the inventory of distributor 126, distributor 126 is less likely to “divert” product to distribution channel 140 without authorization. Optionally, product recall as a means of filling orders contributes to a reduction in production over-runs and/or sales of units of product at reduced prices.

### Advantages to the Consumer

Consumers prefer products which are protected by warranty coverage and/or certified as being authentic. In general consumers look for a product with a long warranty period and/or a reliable warranty service provider. However, many consumers fail to complete simple product registration steps after purchasing a product. As the price of the product increases, the importance of the warranty to the consumer increases although the willingness of the consumer to perform post purchase activation steps does not necessarily increase. Experience has shown that consumers prefer point of sale warranty activation so that they know they are leaving the store with a warranty certificate. Consumers feel even more comfortable with point of sale warranty registration so that they know they are leaving the store with a validated warranty certificate.

Exemplary embodiments of the invention described above permit the consumer to leave the point of purchase with a validated warranty card.

In an exemplary embodiment of the invention, a single consumer 330 has access to warranty information on products from a plurality of manufacturers via DB 350. Centralized storage of information may be useful, for example in establishing ownership when filing an insurance claim for theft or damage and/or in establishing a maintenance record prior to resale.

In an exemplary embodiment of the invention, database 350 resides on, or is associated with, a server adapted to actively initiate communications with consumers 350. Optionally, the server issues reports to consumers 330 regarding a “warranty portfolio” and a status of each item in the portfolio (e.g. warranty expiration date and/or date of purchase and/or warranty term).

In an exemplary embodiment of the invention, a consumer 330 can request a report on one or more items in a warranty portfolio. Optionally, this request can be in the form of a specific query initiated by consumer 330 or can be produced automatically when consumer 330 performs another action. For example, if consumer 330 employs a credit card number as a CID for warranty registration, the consumer may be presented with, or offered access to, a warranty portfolio summary when they log in to a WWW site operated by the credit card company.

In an exemplary embodiment of the invention, the reports are periodic (e.g. quarterly or annual). Optionally, the reports include advertisements and/or promotional information.

In an exemplary embodiment of the invention, the reports are issued when a warranty on one or more items in the portfolio is about to expire (e.g. 30, 60 or 90 days before the expiry date).

Optionally, a report includes an offer to extend a warranty on one or more items in the portfolio for an additional term for a fee.

Optionally, a portfolio summary is issued each time a new warranty is registered. Summaries of this type can be useful in gauging a desired level of insurance coverage. In an exemplary embodiment of the invention, the summaries are organized by category (e.g. consumer electronics; household appliances, and watches/jewelry). Alternatively or additionally, the summaries are organized and/or include an estimation of current replacement value.

Reports from database 350 to consumer 330 may be issued, for example, by mail, e-mail, telephonic text messaging (e.g. SMS or MMS), by fax or any other available communication means. Optionally, consumer 330 designates a preferred communication means for receipt of reports.

### Importance of Warranty Registration to Warranty Service Provider

While manufacturer 110 often provides a warranty for their product, warranty service is often provided locally, for example by importers 124 or 144. The reason for this is that manufacturer 110 is often physically distant from the end-user of a purchased product. Importers 124 and 144 are closer to the end users and may provide service directly or through local sub-contractors. The local sub contractors may be, for example chains of retail stores. This arrangement allows the end user to feel secure in the knowledge that there is a realistic possibility of getting warranty service from a local agent should the need arise.

As an illustrative example the case of manufacturer 110 (Exotica Time) and importer 144 (Acme Imports) is presented. Acme Imports deals in a wide range of goods and has no expertise in watch repair. Nonetheless, they understand Exotica Time watches are unlikely to sell if they are perceived as “unknown” or “unsupported” products. Acme Imports therefore contracts with retailer 150 in the form of Golden Jewelers to provide warranty service at their 406 locations in the distribution area of Acme imports. Acme imports is the “warranty service provider” in the sense that they pay Golden Jewelers for repair services on merchandise under warranty.

Golden Jewelers takes their responsibility of warranty service provision seriously and believes in the retail maxim of “The customer is always right”. As a result, the natural tendency of Golden Jewelers would be to provide service for Exotica Time watches brought in with an apparently valid warranty certificate. The “good will” of Golden Jewelers presents a potential problem for Acme Imports (importer 144) and/or Exotica Time (manufacturer 110) in some cases.

For example, if Exotica Time watches are diverted 132 from distributor 126 in a parallel market channel to wholesaler 148, these items might eventually be presented at Golden Jewelers for service. This places Acme imports in the position of servicing an item which they did not sell and from which they derived no profit.

In an exemplary embodiment of the invention, a stringent warranty validation process as described hereinabove prevents items brought in via “parallel import” from receiving undeserved warranty service. Optionally, this reduces costs for participants in the distribution channel and/or for the end-user.

### Reducing Data Entry by Use of Master UIDs

In an exemplary embodiment of the invention, a container with multiple units of products may be marked with a machine readable “master UID” label. The master UID label can indicate the UIDs of all product units in the container. Optionally, more than 1 level of master is employed. This arrangement contributes to easier tracking throughout the distribution chain as product shipments are broken down into successively smaller lots.

For example, a shipment of 1,000 watches may be organized on palettes of 8 crates of 125 watches/crate. A master UID label on each palette indicates: “thousand A of B thousand; product X; Jan. 1, 2006”. A crate on the palette carries a master UID label indicating. “numbers 1-125 of thousand A; product X; Jan. 1, 2006”. Each individual watch is marked with a UID “number y of 10,000; product X; Jan. 1, 2006”. According to this example importer 144 can apply master UID as described above to each palette, crate and individual watch. The importer enters the palette master UID into database 350 as the palette is shipped to distributor 146. Distributor 146 breaks the received palette down into 8 crates and enters a master UID for each crate into database 350 as the crate is shipped to a wholesaler 148. Wholesaler 148 breaks the received crate down into 125 individual watches and enters a UID for each watch into database 350 as the watch is shipped to retailer 150. Retailer 150 enters the UID of the individual watches into database 350 at the time of sale to associate each watch with a consumer 330.

### Use of a Warranty Certificate as a Promotional Tool

In some exemplary embodiments of the invention, consumer 330 receives a warranty certificate (e.g. card 324) at point of purchase. Optionally, a single certificated serves as a proof of warranty for many purchased items. In other exemplary embodiments of the invention, an existing document (e.g. credit card, driver's license or passports) serves as a warranty certificate for one or more purchased items. Optionally, consumer 330 enters end user data 556 into database 350 as described hereinabove.

According to exemplary embodiments of the invention, the warranty certificate is used to present promotions to consumer 330.

Optionally, the warranty certificate entitles consumer 330 to a future benefit. The future benefit can be, for example, in the form of a gift certificate (i.e. in fixed monetary amount) or entitles consumer 330 to a discount (e.g. defined as a percentage of purchase price or on an incremental scale according to purchase price) applicable to a future purchase and/or a membership in a “consumer club”.

Optionally, the future benefit is assigned to the warranty certificate at a point of purchase or at a later date.

Optionally, the future benefit is provided by, for example, one or more of manufacturer 110, importer 124 or retailer 130.

In an exemplary embodiment of the invention, the future benefit is assigned to the warranty certificate after purchase of the item being placed under warranty and consumer 330 is notified of the future benefit. Notification can be, for example, by e-mail, fax, SMS, telephone or via an Internet site.

In an exemplary embodiment of the invention, the future benefit is assigned to the warranty certificate during purchase of the item being placed under warranty and consumer 330 is made aware of the future benefit at point of purchase. Optionally, awareness of the future benefit comes from information printed on the warranty certificate, on a receipt issued for the purchase and/or from promotional literature and/or graphic displays at point of purchase.

Providing Inventory Control Service to Points of Sale

Some exemplary embodiments of the invention comprise providing inventory control services to points of sale. Optionally, the points of sale are retailers 150 (FIG. 1). According to some exemplary embodiments of the invention, reading devices (e.g. card readers 342; FIG. 3) installed at the points of sale transmit a UID (e.g. a barcode) to a remote database 350 which handles inventory control. Combined bar code magnetic stripe readers are commercially available (e.g. M2500 Serial Wedge, Bar Code & Mag Stripe Reader; American microsystems; USA) and can easily be incorporated into the context of the invention by one of ordinary skill in the art. Optionally, an existing system is retro-fitted by attaching a bar-code reader to an existing system and/or by updating software, optionally by remote. Optionally, codes may be entered using a keypad and/or contact-less reader.

In an exemplary embodiment of the invention, inventory control software is available on a remote server, but is not locally available at points of sale. Optionally, operators of a point of sale have access to their inventory information via a www site. Optionally, reader 342 is integrated into an existing credit card sales registration system or is part of a separate system. Optionally, the separate system records warranty registration data as described above.

In an exemplary embodiment of the invention, the UID is sent to a credit card company, with eth billing information. Optionally, the UID and sales related information is stored in a separate, less secure and/or more accessible database. Optionally, this data is sent to and/or accessible by various actors, for example, as described above.

Alternatively or additionally, UID information is sent to a different location, for example, to the remote server associated with the inventory control and optionally hosted at one or more of the actors. Optionally, such sending is by batch. Alternatively or additionally, the sending is by a separate connection for each sale. Alternatively or additionally, the data is “pulled” by the remote location.

Alternatively or additionally, UID information is sent, with the billing data to the remote server, which then proceeds to send the billing data to a credit card company or other payment server.

In an exemplary embodiment of the invention, access to the billing information and/or sales information, enables various actors in the supply line to coordinate money flow, for example, ensuring payment for stalled inventory or rapid payment of commissions on sales. Optionally, the payment is made to an actor other than the seller and that actor reimburses the seller (e.g., his commission).

In an exemplary embodiment of the invention, the UID (e.g. barcode) used for inventory control and/or warranty registration is separate from an additional identifier used for credit card sales registration. Optionally, a manufacturer 110, an importer 144, distributor 146, or wholesaler 148 applies the UID for inventory control and/or warranty registration in addition to a standard “price tag” bar code.

In an exemplary embodiment of the invention, re-supply of inventory is automated. Optionally, re-supply includes one or more of ordering from a manufacturer, importer and/or distributor. Optionally, inventory information in the database for specific points of sale is available to a supplier of goods to the relevant point of sale.

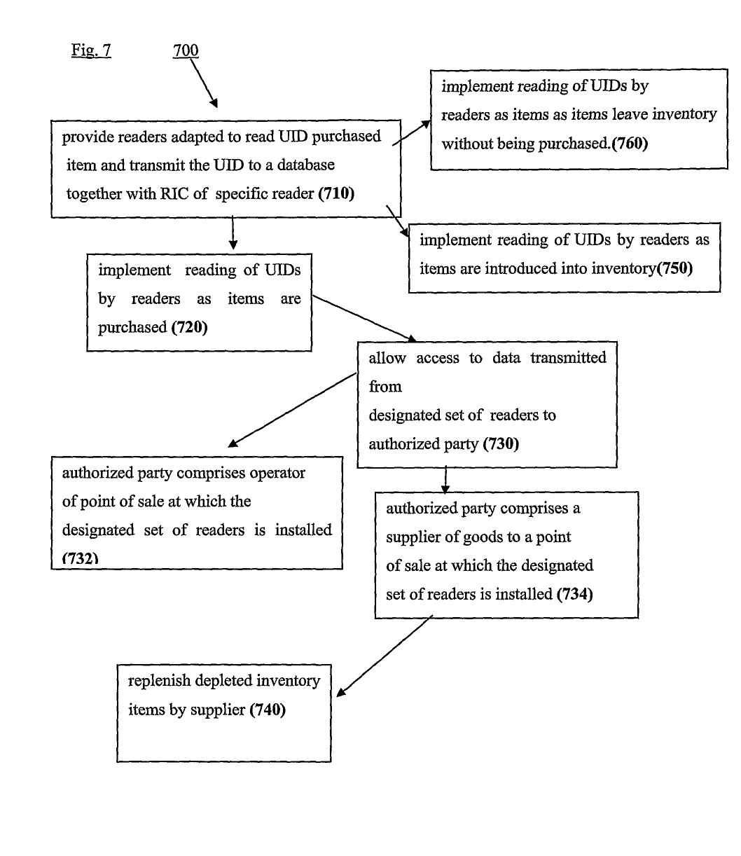

FIG. 7 depicts an exemplary method 700 of providing inventory control service to a point of sale. Optionally, the point of sale can be a manufacturer 110, an importer 144, distributor 146, or wholesaler 148 as depicted in FIG. 1.

Depicted method 700 comprises providing 710 readers adapted to read a unique identifier (UID) of a purchased item and transmit the UID to a database (e.g. database 350 of FIG. 3) together with a reader identification code (RIC) of a specific reader.

Depicted exemplary method 700 also comprises implementing 720 reading of UIDs by the readers as items are purchased; and allowing access 730 to data transmitted from a designated set of readers to an authorized party.

According to some exemplary embodiments of the invention, the authorized party comprises 732 an operator of a point of sale at which the designated set of readers is installed and/or the authorized party comprises 734 a supplier of goods to a point of sale at which the designated set of readers is installed.

Optionally, the supplier uses inventory and/or sales information retrieved the database to replenish 740 depleted inventory items at relevant points of sale. In an exemplary embodiment of the invention, the operator of a point of sale can inactive with respect to inventory management and the supplier assumes responsibility for re-stocking. In some cases, the operator will make special requests. Optionally, the supplier applies sales data from one or more points of sale to formulate a stocking or re-stocking policy for one or more additional points of sale. Optionally, the supplier (or store owner or chain owner) can track the inventory size, delay and/or rate of sale according to various parameters, such as stores, locations, times of day and/or particular salespersons (depending on the data provided by the point-of-sale system, for example, allowing a swipe of an employee card (or key entry) to track salespersons).

In a particular example, if a store sells a pink watch, this information is used to determine (e.g., manually or automatically, such as using rule-systems), that pink watches are moving at that location, prompting the delivery of such watches to that store and/or nearby stores and prompting an order of additional watches from an importer and/or manufacturer. If information re the local stock is available, an order to ship watches by a fast shipping method may be issued. Optionally, at least a check is made to ensure that the stores have an existing and/or sufficient stock of pink watches.

In another example, a distributor or other actor can check the effect and/or efficacy of an advertisement campaign based on an immediate notification of sales. Optionally, a campaign is stopped if sales are too high (for available stock) or if no sales are generated. Examples of short-term campaigns include internet campaigns, direct mailing, cold-calling and electronic display signs. In an exemplary embodiment of the invention, the controlled campaign is 1 month, 1 week, 3 days, 1 day, 5 hours or shorter or intermediate in length.

It should be noted that for unique and high-cost items, inventory levels are desirably low, however, when an item is “in fashion”, the sales rate may be significant. It is also noted that such items (e.g., jewelry) are typically variously customized and/or available in a large number of variants, so that even if a single code (e.g., for general ordering or pricing) is provided per item, each individual item may be different and may therefore be associated with a specific unique ID.

Optionally, the supplier applies sales data from one or more points of sale to formulate an ordering policy from a manufacturer 110, an importer 144, a distributor 146, or a wholesaler 148.

In an exemplary embodiment of the invention, the manufacturer 110 comprises a supplier and responds directly to sales data from one or more points of sale. Optionally, the response includes shipping additional goods to one or more importers 144.

In an exemplary embodiment of the invention, reading of UIDs by the readers is implemented 750 as items are introduced into inventory. Optionally, implementation750 contributes to an ability to ascertain a current inventory level in addition to sales data. Assessment of current inventory level can be valuable to suppliers and/or operators of points of sale.

Alternatively or additionally, UIDs are entered into the system by the supplier as he supplies the items to a location. Alternatively or additionally, a receiving location swipes a plate code, which, in the system, is associated with a plurality of UIDs.

In an exemplary embodiment of the invention, reading of UIDs by the readers is implemented 760 as items leave inventory without being purchased. Optionally, implementation 760 contributes to an ability to ascertain a current inventory level. Items can leave inventory, for example, as part of a recall as described above and/or because the operator of a point of sale returns items to a supplier.

In an exemplary embodiment of the invention, the software of the card swiping system is activated by swiping a warranty card or reading a UID code (e.g., using a bar-code reader). Optionally, this prompts a question related to payment, for example, if to swipe a credit card, accept manual payment and/or return a recalled item. Alternatively, the system may be activated by pressing a button and/or swiping a credit card. Optionally, a standard credit-card sales process include sat its end a question “enter UID?” or the like. Optionally, an existing software is modified by adding such logic there to.

Optionally, the inventory tracking system as described herein tracks sales for items according to bar code and/or cost, where no warranty was issued. Optionally, this is possible by redirecting all sales transactions via the system, rather than directly to credit card company or by receiving such records form credit card company and comparing against the UIDs.

In an exemplary embodiment of the invention, UID tracking is used to provide inventory and process control to repair workshops (e.g., when items is received for repair, leave the repair shop, are transported to manufacture and/or at various workstations thereat) and/or for processing complaints.

It should be noted that both repair shop and a store may service other products which are not tracked by the system and may thus (or otherwise) not have a computerized tracking system. However, by entering the UID information as described herein, optionally via existing or replacement stations as used for regular business, the data can be collected and computerized methods, including such methods as known in the art, can be applied.

It should also be noted that a complete inventory tracking system can include stations of various types including standard stations (e.g., at a warehouse), which serve all products in the warehouse, and stations used only for data entry (e.g., a credit card swiping system), with separate (e.g., WWW) access to information.

Optionally, a point of sale or other actor can purchases the services of such a tracking system to also track products not otherwise supported by the system. For example, server may provide two (or more) levels of inventory control, one for watches, including the chain form distributor to user and another, for pens, including only inventory control of a participating store or chain. Similarly, some products may be tracked at a level of UID and some at a level of general bar-code. Some products may be tracked at different parts of the system in different levels of resolution, for example, UID once it reaches an importer and general bar code and lot number before.

An inventory tracking system may interface with existing systems (e.g., of a manufacturer or a store) and exchange data therewith. In some cases, the resolution of data differs between the systems. Optionally, the system controls remote access (e.g., via WWW) and/or data permissions to the system and/or to such existing systems.

### General

Systems, devices and methods according to the invention optionally rely upon execution of various commands and/or analyses and/or translation of various data inputs. Any of these commands, analyses or translations may be accomplished by software, hardware or firmware according to various embodiments of the invention. The invention includes data storage media such as CD ROM discs containing instructions for execution of these commands and/or analyses and/or translation of various data inputs.

In the description and claims of the present application, each of the verbs “comprise”, “include” and “have” as well as any conjugates thereof, are used to indicate that the object or objects of the verb are not necessarily a complete listing of members, components, elements or parts of the subject or subjects of the verb.

The present invention has been described using detailed descriptions of embodiments thereof that are provided by way of example and are not intended to necessarily limit the scope of the invention. In particular, numerical values may be higher or lower than ranges of numbers set forth above and still be within the scope of the invention. The described embodiments comprise different features, not all of which are required in all embodiments of the invention. Some embodiments of the invention utilize only some of the features or possible combinations of the features. Alternatively or additionally, portions of the invention described/depicted as a single unit may reside is two or more separate physical entities which act in concert to perform the described/depicted function. Alternatively or additionally, portions of the invention described/depicted as two or more separate physical entities may be integrated into a single physical entity to perform the described/depicted function. Alternatively or additionally, portions of the invention described/depicted as a single process or action may be separated into two or more sub-processes or actions to achieve the described result. Alternatively or additionally, portions of the invention described/depicted as two or more separate processes or actions may be integrated into a single process or action to achieve the described result. Variations of embodiments of the present invention that are described and embodiments of the present invention comprising different combinations of features noted in the described embodiments can be combined in all possible combinations including, but not limited to use of features described in the context of one embodiment in the context of any other embodiment. For example, features described in the context of a method or process may be used in a device or system and features described in the context of a device or system may be used in the context of a process or method. The scope of the invention is limited only by the following claims.

All publications and/or patents and/or product descriptions cited in this document are fully incorporated herein by reference to the same extent as if each had been individually incorporated herein by reference.

1.-4. (canceled)

5. A method according to claim 53, further comprising:
(e) implementing reading of the UID by the at least one reader as the item is introduced into inventory.

6. A method according to claim 53, further comprising:
(e) implementing reading of the UID by the at least one reader as the item leaves inventory without being purchased.

7. A method of activating a warranty for a specific item of a product, the method comprising:
(a) applying a unique identifier (UID) to individual items in a post manufacturing process;
(b) entering the UID into a database; and
(c) associating the UID with a unique consumer identifier (CID);
wherein the entering is performed by a retailer acting as a mercantile agent and serves to activate the warranty.

8. A method according to claim 7, wherein the CID is at least one of a credit card number, a driver's license number, a social security number, a phone number, or a frequent flyer number.

9.-12. (canceled)

13. A method of activating a warranty for a specific item of a product, the method comprising:
(a) applying a unique identifier (UID) to individual items in a post manufacturing process;
(b) entering the UID into a database; and
(c) associating the UID with a physical warranty certificate separate from the individual items;
wherein the entering is performed by a retailer acting as a mercantile agent.

14. (canceled)

15. A method according to claim 13, wherein the association includes a physical transfer of a media bearing the UID to the warranty certificate.

16. A method according to claim 13, wherein the association includes storage of data including the UID on a memory attached to the warranty certificate.

17. A method according to claim 13, wherein the UID is provided in a machine readable format.

18. A method according to claim 13, wherein the entering is performed via a credit card reader.

19. A method according to claim 13, wherein the entering is performed via a smart chip reader.

20. A method according to claim 13, wherein the entering is performed via an IVR phone menu.

21. A method according to claim 13, wherein the entering is performed via an RFID reader.

22. A method of warranty registration for a specific item of a product, the method comprising:
(a) incorporating a unique identifier (UID) of a specific item into a credit card type card; and
(b) transmitting the UID to a database using a credit card sales registration system.

23. A method according to claim 22, wherein the incorporating occurs at point of sale.

24. A method according to claim 22, wherein the transmitting occurs at point of sale.

25. A method according to claim 22, performed without registration of a credit card sale.

26.-30. (canceled)

31. A two-part warranty certificate; the certificate comprising:
(a) a token bearing a magnetic media encoded with a unique identifier (UID) of a specific item; and
(b) a card with a magnetic stripe interrupted by a receptacle adapted to retain the token;
wherein the magnetic stripe retaining the token is compatible with a standard magnetic stripe card reader for purposes of reading at least the UID.

32. A certificate according to claim 31, wherein the token is associated with a package containing the specific item and is transferable to the card at a point of purchase.

33. A certificate according to claim 31, wherein the token is associated with the specific item and is transferable to the card at a point of purchase.

34.-35. (canceled)

36. A magnetic stripe card; the card comprising:
a smart chip adapted to:
(i) receive and store a unique identifier (UID) for a purchased item of merchandise from a smart chip writer at a point of purchase; and
(ii) transmit the UID to a smart card reader operated by a warranty service operator.

37. A card according to claim 36, configured to operate as a credit card.

38. A card according to claim 36, configured to operate as a debit card.

39.-42. (canceled)

43. A method of inventory control, the method comprising:
(a) requiring members of a distribution channel to log receipt and disbursement of items in inventory into a database; and,
(b) permitting any member in the distribution channel to track items previously in their inventory.

44. A method according to claim 43, wherein a manufacturer can monitor retail sales data for their product in the database at a level of individual units of product.

45. A method of verifying authenticity of a product, the method comprising:
(a) requiring members of a distribution channel to log receipt and disbursement of items in inventory into a database;
(b) refusing to log receipt of items if a disbursement of corresponding items is not present in the database; and
(c) logging receipt of items if a disbursement of corresponding items is not present in the database.

46.-52. (canceled)

51. A method of providing inventory control throughout a distribution channel among a plurality of different participants in the distribution channel, comprising:
(a) providing at least one reader device associated with a specific point of sale and adapted to read data comprising at least a unique identifier (UID) of a purchased item;
(b) transmitting the data including the UID to a database;
(c) activating a warranty based on an association between the UID and the point of sale; and,
(d) providing access to the data transmitted from the at least one reader to the different participants.

54. A method according to claim 53, further comprising designating a legitimate distribution channel comprised of one or more of the different participants associated with the UID.

55. A method according to claim 54, wherein activating is performed only if the UID matches the legitimate distribution channel.

56. A method according to any of claims 53, further comprising replenishing depleted inventory by at least one of the different participants in response to the number of items sold as recorded on the database.

57. A method according to any of claims 53, wherein read data includes a consumer identifier (CID).

58. A method according to claim 57, further comprising associating on the database the CID with at least one UID.

59. A method according to claim 58, further comprising rendering warranty support to an item bearing a specific UID upon the presentation by a consumer of the CID associated with the UID on the database.

60. A method according to claim 58, wherein a consumer accesses warranty information on the database of at least one item bearing a UID using the consumer's CID.

61. A method according to any of claims 53, further comprising logging receipt and disbursement of an item bearing a UID by at least one of the different participants into the database.

62. A method according to claim 61, further comprising automatically refusing receipt of the item from one of the participants if the participant is not in a legitimate distribution channel recorded on the database for the item.
